(19) United States
(12) Patent Application Publication
(10) Pub. No.: US 2026/0024153 A1
(43) Pub. Date: Jan. 22, 2026

(54) INTELLECTUAL PROPERTY VALUATION SYSTEM UTILIZING ARTIFICIAL INTELLIGENCE

(71) Applicant: Korea Invention Promotion Association, Seoul (KR)

(72) Inventors: Jungae Kwak, Seoul (KR); Ho-Young Woo, Seoul (KR); Jae Woo Song, Gyeonggi-do (KR)

(73) Assignee: Korea Invention Promotion Association, Seoul (KR)

(21) Appl. No.: 19/270,010

(22) Filed: Jul. 15, 2025

(30) Foreign Application Priority Data
Jul. 16, 2024 (KR) 10-2024-0093890
Jun. 5, 2025 (KR) 10-2025-0073972

(51) Int. Cl. G06Q 50/18; G06Q 30/0202

(52) U.S. Cl. CPC G06Q 50/184; G06Q 30/02022

(57) ABSTRACT

The present disclosure is to an Artificial Intelligence based Intellectual Property valuation system, including a valuation database that includes, as raw data, reference information, patent data, and economic statistical information, and, as extracted information processed from the raw data, statistical data and AI training dataset, a collection/refinement module that processes the raw data, computes and provides the statistical data required in a process of generating the AI training dataset or key variables, computes the AI training dataset, and stores the same, an AI module that, for outputting the key variables, trains AI models for the respective key variables, identifies, and, through the AI models, computes corresponding prediction-variable values using respective explanatory-variable values collected by the collection/refinement module to output respective key-variable values, and a valuation service module that computes a value of the target IP based on the key-variable values and generates a valuation report including the statistical data.

### CROSS-REFERENCE TO RELATED APPLICATION

This application claims priority to and the benefit of Korean Patent Application No. 10-2024-0093890 filed in the Korean Intellectual Property Office on Jul. 16, 2024, and Korean Patent Application No. 10-2025-0073972 filed in the Korean Intellectual Property Office on Jun. 5, 2025, the entire contents of which are incorporated herein by reference.

### BACKGROUND

### (a) Technical Field

The present disclosure relates to an AI-based intellectual property (IP) valuation system that matches patent classification information with industry classification information or import/export codes to link and combine patent statistical information, industry classification information, and company information; collects and processes diverse data to derive, from raw data, relevant statistical data and training dataset for training AI models; estimates, through the AI models, key variables such as the Economic Lifespan of IP, royalty rate, discount rate, and sales revenue, necessary for valuation; and provides IP valuation results together with related statistical data.

### (b) Description of the Related Art

Demand for intellectual property (IP) valuation has continued to increase; however, conventional expert-based valuation makes it difficult to ensure consistency in valuation results due to the subjectivity of experts and requires a considerable amount of time for preliminary research and report preparation.

In addition, when a valuation is to be performed for patents owned by a business entity, the valuation is generally conducted for a patent portfolio including several patents secured in connection with the business, rather than for a single patent.

In such cases, there has been a difficulty in that the time and resources to be expended increase as the number of patents included in the portfolio increases.

Further, there have been solutions that receive, from respective experts or users, evaluation results for individual evaluation factors required to produce a valuation output and, based on the input data, compute a patent value or grade; however, expert assessments of the individual evaluation factors are inevitably involved, or the input data employed is limited, resulting in valuation results that are simple and restricted.

Further, when only the valuation result for a patent is provided, non-experts have had difficulty interpreting and utilizing the valuation results.

### THE PRIOR ART

(Non-Patent Literature 1) Managing Technology: The Technology Valuation Approach (IEEE, 2007)
(Non-Patent Literature 2) A Comparative Study on Methods of Income Approach to Technology Valuation (Journal of Supply Chain and Operations Management, Volume 10, Number 2, September 2012)
(Non-Patent Literature 3) Internal technology valuation: real world issues (International Journal of Technology Management, Vol. 53, No. 2-4, 2011)
(Non-Patent Literature 4) Income approach to technology valuation for innovations (International Journal of Technology Management, Vol. 88, No. 2-4, 2022)
(Non-Patent Literature 5) Review on Methods of New Technology Valuation (IEEE, 2010)

### SUMMARY

Accordingly, the technical problem to be solved by the present disclosure is to provide a system that, based on objective input data from general users including non-experts, can perform IP valuation without relying on experts' subjective judgment.

Additionally, in IP portfolio valuation, the technical problem to be solved by the present disclosure is to provide a system that, rather than summation of independent evaluation of each patent or conducting valuation after selecting core patents based on the subjective judgment of a business entity or experts, performs valuation objectively and efficiently on a portfolio-wide basis without being affected by the number of individual patents.

Additionally, the technical problem to be solved by the present disclosure is to enhance the reliability of the system's valuation results by (i) estimating, through AI models, the values of key variables required for valuation, (ii) training the AI models using various types of data, including financial data, economic data and patent data, and input datasets, and (iii) utilizing outputs of models optimized for the respective key variables.

Further, the technical problem to be solved by the present disclosure is to provide a system that provides, together with the valuation results, related statistical data that have been utilized or processed for estimating key variables and performing the valuation, to aid interpretation of the results and to provide insights into the relevant industrial environment.

According to one aspect of the present disclosure for solving the foregoing technical problems, an IP (Intellectual Property) valuation system is an AI (Artificial Intelligence)-based IP valuation system, including: a valuation database that includes, as raw data, reference information, patent data, and economic statistical information, and that includes, as extracted information processed from the raw data; statistical data and AI training dataset; a collection/refinement module that collects and processes the raw data, computes and provides statistical data required in a process of generating the AI training dataset or first through fourth key variables, computes the AI training dataset, and stores the same in the valuation database; an AI module that, for outputting the first through fourth key variables, trains two or more AI models for each key variable by using the AI training dataset, identifies, based on input information on an IP to be evaluated, explanatory variables matched to each key variable, and outputs values of the key variables by computing, through the AI models, corresponding prediction-variable values using respective values of the explanatory variables collected or computed by the collection/refinement module, wherein the AI module outputs a first prediction variable and a first key-variable value through a first explanatory-variable set, outputs a second prediction variable and a second key-variable value through a second explanatory-variable set, outputs a third prediction variable and a third key-variable value through a third explanatory-variable set, and outputs a fourth prediction variable and a fourth key-variable value through a fourth explanatory-variable set; and a valuation service module that computes a value of a target IP based on the first through fourth key-variable values and generates a valuation report including the IP value and the statistical data.

In this case, the first through fourth key variables are, respectively, the Economic Lifespan of IP, royalty rate, discount rate, and sales revenue.

Further, the first through fourth prediction variables are, respectively, a factor influencing Economic Lifespan of IP, a factor influencing royalty rate, an IP commercialization risk premium, and a sales growth rate.

Additionally, during training of the respective AI models, the first through fourth prediction variables are defined and learned as follows: a difference between the expert-evaluated Economic Lifespan of IP and the median Technology Cycle Time (TCT) of the patent classification to which the target IP belongs; a ratio of the expert-evaluated royalty rate to an industry benchmark royalty rate determined by matching the patent classification information of the target IP to industry classification information; an expert-evaluated IP commercialization risk premium; and an industry-specific sales growth rate.

Further, the AI module checks a TCT (Technology Cycle Time) median of the patent classification information to which the target IP belongs and, by reflecting the first prediction-variable value in the TCT median, outputs the first key variable; checks, through industry classification information matched to the patent classification information to which the target IP belongs, a benchmark royalty rate for the relevant industry and, by reflecting the second prediction-variable value in the benchmark royalty rate, outputs the second key variable; checks, through the industry classification information matched to the patent classification information to which the target IP belongs, a cost of equity and its weight and a cost of debt and its weight for the relevant industry and, by reflecting the third prediction-variable value in the cost of equity, outputs the third key variable; and, when past sales of a business entity owning the target IP are available, sets an initial sales revenue based on the past sales and, by reflecting the fourth prediction-variable value in the initial sales revenue, outputs the fourth key variable.

Further, when past sales of the business entity owning the target IP are not available, the AI module sets the initial sales revenue using sales statistics for enterprises of a predefined size class in the relevant industry.

Further, the first explanatory-variable set for generating the first prediction variable includes: a growth rate of the number of application and applicant (application-growth rate/applicant-growth rate), TCT (Technology Cycle Time) statistical values, evaluation factors of a rating evaluation system, metric scores of the rating evaluation system, an average number of U.S. patent litigations by patent classification information, and an average number of trial/appeal-related cases by patent classification information; the second explanatory-variable set for generating the second prediction variable includes: royalty-rate statistics, an average number of Office Action responses by patent classification, evaluation factors of a rating evaluation system, metric scores of the rating evaluation system, and counts of continuing patent applications and priority claims by patent classification; the third explanatory-variable set for generating the third prediction variable, optimized for predicting the IP commercialization risk premium, includes: sales growth rates by industry and by enterprise size, operating-profit growth rates by industry and by enterprise size, evaluation factors of the rating evaluation system, metric scores of the rating evaluation system, and patent concentration index; and the fourth explanatory-variable set for generating the fourth prediction variable includes: growth rates of the number of applicants and of the number of application, and import/export growth rates.

Further, the target IP information is the patent number of the Valuation IP.

Further, the valuation service module computes the value of the target IP, based on the first through fourth key-variable values, by applying the relief-from-royalty method.

Further, the reference information includes expert IP evaluation result data and actual IP transaction information data; the patent data includes, as patent details, per-patent forward/backward citation data, application data, patent trial/appeal data, litigation data, registration data, and family data, and, as rating-evaluation information, per-patent rating-evaluation-factor data and score data for the indicators represented by the respective evaluation factors according to the evaluation results for each factor; and the economic statistical information includes, as economic-market information, industry-sales-growth-rate data, sales statistical data, and macro-economic data, as financial information, stock-price data, bond-interest-rate data, and corporate financial-sheet data, and, as import/export information, import/export data.

In this case, the collection/refinement module includes: a raw-data collection unit that collects the raw data; a preprocessing unit that performs preprocessing on the collected raw data; a base-data generation unit that, from the preprocessed data, generates base data for deriving training dataset and evaluation-criteria data; a training-data generation unit that, from the base data, generates AI-model training dataset for calculating the key variables; a statistical-data generation unit that, as statistical data generated or required in the course of creating the AI training dataset or calculating the key variables, generates statistical data for one or more of the explanatory variables, the prediction variables, and the key variables; and an evaluation-criteria-data generation unit that, based on the first through fourth key-variable values output by the AI module, computes final evaluation-criteria data and provides it to the valuation service module.

Further, the evaluation-criteria-data generation unit finally outputs, as evaluation-criteria data, an Economic Lifespan of IP that takes into account one or more of the remaining legal life of the target IP and the commercialization lead time as the first key-variable value, and computes a corporate tax rate and corporate tax based on the computed sales revenue.

Further, the statistical data, as statistical information utilized or extracted in the course of outputting the first key variable, includes TCT (Technology Cycle Time) data for the relevant patent classification, trial/appeal related statistical data, U.S. litigation data, and market-concentration index data for the relevant industrial sector; as statistical information utilized or extracted in the course of outputting the second key variable, includes industry benchmark royalty-rate data, the number of Office Action responses for the relevant patent classification, the number of continuing applications, and the number of priority claims; as statistical information utilized or extracted in the course of outputting the third key variable, includes cost-of-equity and cost-of-debt data and industry-specific equity/debt ratio data for the relevant industry, patent concentration index for the relevant patent classification, and sales-growth-rate and operating-profit-growth-rate data by industry; and as statistical information utilized or extracted in the course of outputting the fourth key variable, includes initial sales-revenue statistics according to the industry and enterprise-size class to which the target IP belongs, applicant-count and application-count growth-rate statistics for the relevant patent classification, and import/export growth-rate data for the relevant industry and item.

Further, the AI module includes: a training-data preprocessing unit that performs preprocessing on the AI training dataset; an AI training unit that, using the AI training dataset, trains one or more AI models for each of the first through fourth key variables; a training-optimization unit that, based on validation results for the AI models' predicted values, sets, for each key variable, one or more optimized AI models according to performance-metric results; and a key-variable output unit that outputs the key variables through explanatory variables matched to the respective key variables and prediction variables computed through the AI models.

Further, when the number of IPs to be evaluated is two or more, thereby constituting an IP portfolio, the key-variable output unit sets, as a baseline TCT for the target IP portfolio, an average of TCT medians for the respective patent classification information of the individual patents; computes, for each individual patent, a factor influencing Economic Lifespan of IP and sets, as a first prediction variable for the target portfolio, the factor having the largest value; reflects the first prediction-variable value in the portfolio's baseline TCT to output a first key variable for the target portfolio; sets an industry either according to user input or, among industries corresponding to industry classification information matched to the respective patent classification information of the individual patents, sets as a representative industry for the target portfolio the industry whose median sales of small enterprises is the largest, sets a benchmark royalty rate value of the representative industry as a benchmark royalty rate for the target portfolio, computes, for each individual patent, a factor influencing the royalty rate and sets, as a second prediction variable for the target portfolio, the factor having the largest value, and reflects the second prediction-variable value in the portfolio's benchmark royalty rate to output a second key variable for the target portfolio; computes, for each individual patent, an IP commercialization risk premium and sets, as a third prediction variable for the target portfolio, the smallest IP commercialization risk premium, and reflects the third prediction-variable value in the cost of equity within a weighted-average cost of capital of the representative industry for the target portfolio to output a third key variable for the target portfolio; generates a fourth prediction variable for the target portfolio based on patent classification information and import/export item classification information matched to the representative industry for the target portfolio, sets an initial sales revenue through past sales information of the business entity or sales statistics of the representative industry of the target portfolio, and reflects the fourth prediction-variable value in the initial sales revenue to output a fourth key variable for the target portfolio.

As described above, according to the present disclosure, it is possible to perform IP valuation, based on objective input data from general users including non-experts, without a subjective expert evaluation stage.

For example, according to the present disclosure, in IP portfolio valuation, it is possible to perform an efficient and objective valuation expeditiously regardless of the number of individual patents.

Further, according to the present disclosure, by generating diverse AI training dataset and utilizing a plurality of AI models trained using the AI training dataset, highly reliable valuation results can be obtained.

Further, according to the present disclosure, by additionally providing related statistical data that are utilized or produced in estimating the key variables required for valuation or in the valuation process, it is possible to provide users with insights into the relevant industrial environment and the utilization of IP.

### BRIEF DESCRIPTION OF THE DRAWINGS

FIG. 1 is an overall configuration diagram of an IP valuation system according to one aspect of the present disclosure.

FIG. 2 is a detailed configuration diagram of the valuation service module according to one aspect of the present disclosure.

FIG. 3 is a detailed configuration diagram of the collection/refinement module according to one aspect of the present disclosure.

FIG. 4 is a detailed configuration diagram of the AI module according to one aspect of the present disclosure.

FIG. 5 is a detailed configuration diagram of a stacking ensemble model according to one aspect of the present disclosure.

FIG. 6 illustrates, for calculating the first key variable-Economic Lifespan of IP-among the key variables computed for patent valuation, an example of explanatory-variable items input to the AI model and the prediction variable.

FIG. 7 illustrates, for calculating the second key variable-royalty rate-among the key variables computed for patent valuation, an example of explanatory-variable items input to the AI model and the prediction variable.

FIG. 8 illustrates, for calculating the third key variable-discount rate-among the key variables computed for patent valuation, an example of explanatory-variable items input to the AI model and the prediction variable.

FIG. 9 illustrates, for calculating the fourth key variable-sales revenue-among the key variables computed for patent valuation, an example of explanatory-variable items input to the AI model and the prediction variable.

FIG. 10 is a detailed configuration diagram of a valuation management module according to one aspect of the present disclosure.

FIG. 11 is a detailed configuration diagram of the valuation database according to one aspect of the present disclosure.

FIG. 12 illustrates an overall flow in which, according to one aspect of the present disclosure, the system evaluates the value of the target IP based on objective target-IP information input by a user and generates a report.

FIG. 13 illustrates an overall flow of user input of target flow information according to one aspect of the present disclosure,

FIG. 14 illustrates an overall flow of the system computing a final portfolio value based on objective target IP portfolio information input by a user.

FIG. 15 is a diagram illustrating an example of a computer apparatus according to one aspect of the present disclosure.

### DETAILED DESCRIPTION OF THE EMBODIMENTS

Hereinafter, embodiments of the present disclosure will be described in detail with reference to the accompanying drawings so that those of ordinary skill in the art to which the present disclosure pertains can readily practice the disclosure. However, the present disclosure may be implemented in various different forms and is not limited to the embodiments described herein.

In the drawings, portions unrelated to the description are omitted for clarity, and like reference numerals are used to designate like elements throughout the specification.

Throughout the specification, when a part is said to “include” a certain element, it means, unless expressly stated otherwise, that other elements are not excluded and may be further included.

In addition, the terms “ . . . unit,” “ . . . apparatus,” and “ . . . module” as used in the specification denote a unit that processes at least one function or operation, and may be implemented in hardware, software, or a combination of hardware and software.

The apparatuses described in the present disclosure are constituted of hardware including at least one processor, a memory device, and a communication device, and store, in a designated location, a program that is executed in conjunction with the hardware. The hardware has a configuration and performance capable of executing the methods of the present disclosure. The program includes instructions that implement the method of operation of the present disclosure as described with reference to the drawings and, in combination with hardware such as the processor and the memory device, executes the present disclosure.

As used herein, “transmit” or “provide” may include not only directly transmitting or providing, but also indirectly transmitting or providing via another device or through a bypass route.

In this specification, unless explicit terms such as “one” or “single” are used, expressions written in the singular may be construed in the singular or the plural.

In this specification, the same reference numerals denote the same elements regardless of the drawings, and “and/or” includes each of the recited elements and any and all combinations of one or more of the recited elements.

In this specification, terms including ordinals such as first and second may be used to describe various elements, but the elements are not limited by such terms. Such terms are used solely for the purpose of distinguishing one element from another. For example, without departing from the scope of the present disclosure, the first element may be referred to as the second element, and likewise the second element may be referred to as the first element.

In the flowcharts described with reference to the drawings in this specification, the order of operations may be changed, multiple operations may be combined, an operation may be divided, and a particular operation may not be performed.

Further, among various methodologies utilized for IP valuation, the present disclosure applies the relief-from-royalty method. In this context, the relief-from-royalty method is a method of estimating the value of the target IP by estimating the reasonable royalty that would be incurred absent ownership of rights in the target IP. Hereinafter, by way of example, this specification describes the case in which the target IP is a patent.

More specifically, in patent valuation, the relief-from-royalty method is a valuation approach that estimates the present value of the royalties that would need to be paid as licensing costs during the economic lifespan of the target patent.

The relief-from-royalty method is suitable for valuing patents of startups or small- and medium-sized enterprises that own the IP but are not yet generating revenue, and is also suitable for evaluating R&D-derived patents for which commercialization cannot readily be assumed.

When valuing a patent using the relief-from-royalty method, the specific calculation formula is as follows:

$$patent value = {\sum }_{t = 1}^{n} \frac{{S}_{t} \times R - {C}_{t}}{{( 1 + r )}^{t}} \qquad ( Equation 1 )$$

n: Economic Lifespan of IP; S: estimated sales revenue.
R: royalty rate; C: corporate tax expense; r: discount rate.

Accordingly, according to the present disclosure, the IP valuation system can, based on objective input data from users, compute as key variables the Economic Lifespan of IP of the target IP (also referred to as the “first key variable”), a royalty rate (also referred to as the “second key variable”), a discount rate (also referred to as the “third key variable”), and an estimated sales revenue (also referred to as the “fourth key variable”), and perform valuation of the target patent.

Hereinafter, the IP valuation system according to one aspect of the present disclosure will be described in greater detail with reference to the drawings.

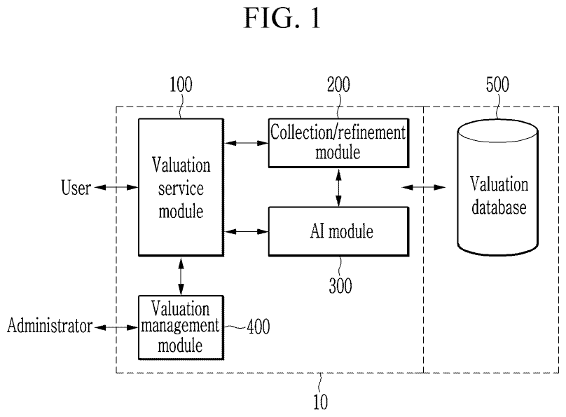

First, as shown in FIG. 1, an IP valuation system 10 may include a valuation service module 100, a collection/refinement module 200, an AI module 300, a valuation management module 400, and a valuation database 500.

The valuation service module 100 may receive, from a user, objective information data relating to the target IP, receive evaluation-criteria data generated based on the information data, compute the IP value, and generate a report.

Specifically, the valuation service module 100 may provide an interface through which a user inputs information on the target IP and may receive the information.

Further, as objective information data, the valuation service module 100 may, at the user's selection, also receive business-entity information for the owner of the target IP, i.e., information relating to enterprise size or industry.

The valuation service module 100 may manage valuation attributes for the target IP; for example, it may manage attribute information such as a valuation purpose and a valuation method.

The valuation service module 100 may perform IP valuation, according to the set valuation purpose and method, by using evaluation-criteria data derived from the target IP information.

Further, the valuation service module 100 may generate an IP valuation report including the IP valuation results and related statistical data produced in the course of the valuation process.

The collection/refinement module 200 may periodically collect raw data required for IP valuation, refine and process the information, and extract required information.

Specifically, the collection/refinement module 200 may, as reference information, collect, for example, expert IP valuation data, technology transfer data of universities, technology transfer data of public research institutes, and IP exchange transaction data.

Further, the collection/refinement module 200 may, as patent data, collect, for example, forward/backward citation data for the relevant patent, application data, trial/appeal/litigation data, registration data, family data, and rating-evaluation data.

Further, the collection/refinement module 200 may, as economic statistical information among public data, collect, for example, sales-growth-rate data, sales statistical data, macro-economic data, stock-price data, bond-interest-rate data, corporate financial-sheet data, and import/export data.

The collection/refinement module 200 may extract, from the raw data, required information, including related statistical data and training dataset for AI training.

Specifically, the collection/refinement module 200 may extract, from the raw data, statistical information such as patent citation life by IPC, industry-specific benchmark royalty rates, industry-specific costs of equity and debt, and industry-specific equity/debt ratios.

Further, the collection/refinement module 200 may extract, as AI training dataset, for example: patent concentration index; counts of trial/appeals and litigations; counts of prior IPs; counts of technology transfers; counts of license grants; depth of dependent claims of the target IP; number of claim chains; number of Office Action responses; number of continuing applications; number of claims; forward-citation count; industry-specific CAGR (Compound Annual Growth Rate); industry-specific sales statistical information; industry-specific sales growth rates; import/export growth rates; macro-economic; and application growth-rate data by IPC.

The AI module 300 may receive AI training dataset from the collection/refinement module 200 and, after preprocessing the same, train AI models for calculating the key variables using the training dataset.

The AI module 300 may, through respective AI models optimized through training, output key variables required for valuation based on user input data.

The valuation management module 400 may perform management functions for the IP valuation system 10.

Specifically, the valuation management module 400 may manage reference information for executing IP valuation and may perform management of system users and of the system. Further, the valuation management module 400 may execute a fee-payment process for use of the IP valuation service.

The valuation database 500 may store the collected raw data and information processed and extracted from the raw data.

The valuation database 500 may store reference information, patent data, and economic statistical information collected by the collection/refinement module 200, and, as extracted information processed by the collection/refinement module 200, statistical data and AI training dataset.

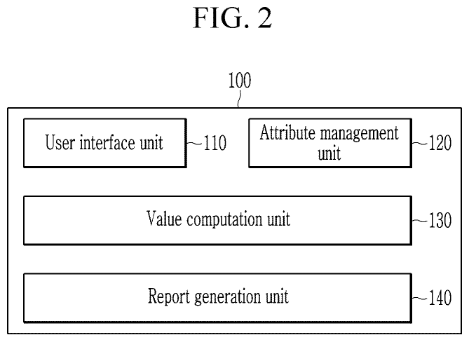

Hereinafter, with reference to FIGS. 2 to 10, the modules (100-400) and the valuation database 500 will be described in detail.

As shown in FIG. 2, the valuation service module 100 may include a user interface unit 110, an attribute management unit 120, a value computation unit 130, and a report generation unit 140.

Specifically, the user interface unit 110 provides an interface through which a user can input information on the target IP and, additionally, can select or input information relating to the business entity's enterprise size or industry.

The attribute management unit 120 may manage, as IP valuation attributes, attribute information such as an IP valuation purpose and an IP valuation method. For example, the attribute management unit 120 may set an IP-collateralized loan as the valuation purpose and the relief-from-royalty method as the valuation method.

The value computation unit 130 may receive evaluation-criteria data required for computing a value according to the valuation method (in the present disclosure, the relief-from-royalty method) and may compute the IP value from the evaluation-criteria data.

Specifically, the value computation unit 130 may compute the value of the target IP using the specific calculation formula of Equation (1).

The report generation unit 140 may generate an IP valuation report including not only the IP valuation results but also related statistical data produced in the course of the valuation process.

For example, the report generation unit 140 may first include, in connection with estimating the Economic Lifespan of IP of the target IP, TCT (Technology Cycle Time) statistics by IPC for the IPC(s) (International Patent Classification) corresponding to the target IP.

Specifically, the report generation unit 140 may generate a report that, for the target IP, includes as TCT statistics for the relevant IPC(s) information on the first quartile, median, mean, and third quartile based on Korean and U.S. patent citation lives.

Additionally, the report generation unit 140 may include, as training data extracted and utilized for calculating the Economic Lifespan of IP, trial/appeal-related statistical analysis information for the relevant IPC, thereby enabling identification of the competitive intensity of the IP.

Similarly, the report generation unit 140 may include initial sales-revenue statistical information for the industry of the relevant business entity that is extracted and utilized for calculating sales revenue, and may include, as training data, information on growth rates of the number of applicants and the number of filings for the relevant IPC, as well as import/export growth-rate information by item, thereby enabling identification of trends in the industrial sector corresponding to the IPC, operating profitability, and market growth trends.

Additionally, the report generation unit 140 may provide, as a benchmark royalty rate used for calculating the royalty rate, royalty-rate statistical information for the relevant industry, and may also provide, as reflected in the training dataset, statistical information for the relevant IPC on the number of Office Action responses, continuing applications, and domestic priority claims, thereby enabling use in assessing the stability of rights in the IP, continuity of research, and prospects for future development.

Further, the report generation unit 140 may also provide, as discount-rate-related statistics for the relevant industry used in calculating the discount rate, information on the cost of debt and the cost of equity derived from stock information, bond information, and financial information. Further, the report generation unit 140 may provide, in comparison with the overall industry average, information on operating-profit growth rates by enterprise size and sales-revenue CAGR for the relevant industry-extracted and utilized as training data for calculating the discount rate-thereby enabling use in assessing the operating-profit stability or margin outlook of the relevant industry relative to the overall industry.

Meanwhile, the IPC (International Patent Classification) is an internationally standardized patent classification scheme representing the technical field of an invention and is an example of IP classification information according to the present disclosure. The IP classification information is not limited to the IPC alone and may also include the CPC (Cooperative Patent Classification) and other patent classification schemes. Hereinafter, IPC will continue to be used as an example of the IP classification information.

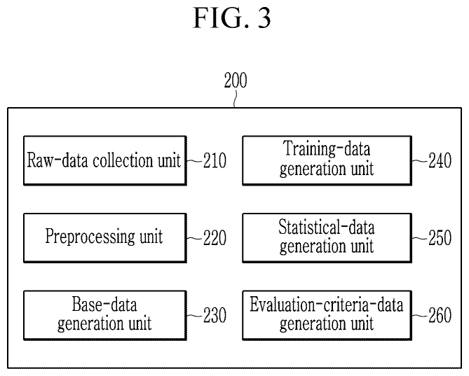

Meanwhile, as shown in FIG. 3, the collection/refinement module 200 may include a raw-data collection unit 210, a preprocessing unit 220, a base-data generation unit 230, a training-data generation unit 240, a statistical-data generation unit 250, and an evaluation-criteria-data generation unit 260.

The raw-data collection unit 210 may collect source data utilized for IP valuation. First, as reference information serving as the basis for valuation, it may collect expert IP valuation data previously conducted and actual IP transaction information data.

Further, the raw-data collection unit 210 may collect, as patent data from existing IP information-providing systems, per-IP forward/backward citation data, application/trial/litigation/registration data, design patent data, and family data.

Further, the raw-data collection unit 210 may collect rating-evaluation data from an IP rating evaluation system.

Further, the raw-data collection unit 210 may collect, as economic statistical information, sales-growth-rate data, sales statistical data, macro-economic data, stock-price data, bond-interest-rate data, corporate financial-sheet data, and import/export data.

The preprocessing unit 220 may first parse and cleanse the collected source data and perform preprocessing.

The base-data generation unit 230 may generate, from the collected and preprocessed data, respective base data for AI training dataset and for evaluation-criteria data.

The training-data generation unit 240 may generate, from the base data, AI-model training dataset used to estimate the respective prediction variables for calculating the key variables for IP valuation.

For example, as training dataset input to the AI model for calculating the Economic Lifespan of IP, the training-data generation unit 240 may generate training dataset that uses, as the prediction variable, the difference between the expert evaluation result for Economic Lifespan of IP (reference information) and the median TCT for the corresponding IPC (hereinafter also referred to as the “factor influencing Economic Lifespan of IP”), and uses, as explanatory variables, growth rates of the number of applicants and of the number of applications, patent concentration index, TCT statistical values, evaluation factors of a rating evaluation system, metric scores of the rating evaluation system, U.S. litigation statistics by IPC, and trial/appeal statistics by IPC, and the like.

Further, as training dataset input to the AI model for calculating the royalty rate, the training-data generation unit 240 may generate training dataset that uses, as the prediction variable, a ratio between an expert-evaluated royalty rate serving as reference information and a benchmark royalty rate for the relevant industry (hereinafter also referred to as the “factor influencing the benchmark royalty rate”), and that uses, as explanatory variables, benchmark royalty-rate statistics, the number of Office Action responses, evaluation factors of a rating evaluation system, metric scores of the rating evaluation system, the number of continuing applications, the number of priority claims, and an average depth of dependent claims.

Further, as training dataset input to the AI model for calculating the discount rate, the training-data generation unit 240 may generate training dataset that uses, as the prediction variable, an expert-evaluated IP commercialization risk premium, and that uses, as explanatory variables, sales growth rates by enterprise size and by industry, operating-profit growth rates by enterprise size and by industry, evaluation factors of a rating evaluation system, metric scores of the rating evaluation system, patent concentration index, and the like.

Further, as training dataset input to the AI model for calculating sales revenue, the training-data generation unit 240 may use a sales growth rate as the prediction variable and generate training dataset by using, as explanatory variables, import/export growth rates by industry and application growth rates by IPC, and the like.

The statistical-data generation unit 250 may generate related statistical data required in the course of generating AI training dataset or calculating the key variables.

The statistical-data generation unit 250 may provide statistical data for the reference information, basic statistics for the key variables, and statistics by explanatory variable.

Specifically, the statistical-data generation unit 250 may compute TCT (Technology Cycle Time) statistics by IPC, trial/appeal-related statistical analysis information, initial sales-revenue statistical information for the business entity, growth rates of the number of applicants and of the number of applications by IPC, item-specific import/export growth-rate information identified through matching between IPC and import/export codes, costs of equity and of debt by industry and enterprise size, equity/debt ratios by industry and enterprise size, patent concentration index by IPC, statistical information on sales-revenue and operating-profit growth rates by industry and enterprise size, industry-specific benchmark royalty rate statistics, and statistical information on the number of Office Action responses, continuing applications, and priority claims by IPC, and the like.

According to the present disclosure, statistical information for each key variable may be computed by incorporating the estimation results of the prediction variables output by two or more AI models for the respective key variable.

In this case, the statistical-data generation unit 250 may compute statistical information on the estimated values of the prediction variables or statistical information for the respective key variables and provide the same to the user through the report.

Accordingly, the user may be provided with, and may utilize, not only the median of the relevant key variable or of a prediction variable related to the key variable, but also one or more of information on the first quartile, the third quartile, and the mean.

The evaluation-criteria-data generation unit 260 may, based on the computed statistical data and the key variables, finally compute evaluation-criteria data to be input into the valuation formula.

Specifically, the evaluation-criteria-data generation unit 260 may ascertain the remaining legal life of the target IP and compare it with the Economic Lifespan of IP output by the AI module.

The evaluation-criteria-data generation unit 260 may, based on the comparison, determine the shorter remaining life as the final Economic Lifespan of IP of the target IP, or, when a commercialization lead time is required, compute the final Economic Lifespan of IP of the target IP by taking that period into account.

Further, the evaluation-criteria-data generation unit 260 may determine a corporate tax rate and finalize the corporate tax expense. The evaluation-criteria-data generation unit 260 may compute a final corporate tax expense by applying the determined corporate tax rate to the sales revenue over the final Economic Lifespan of IP of the target IP.

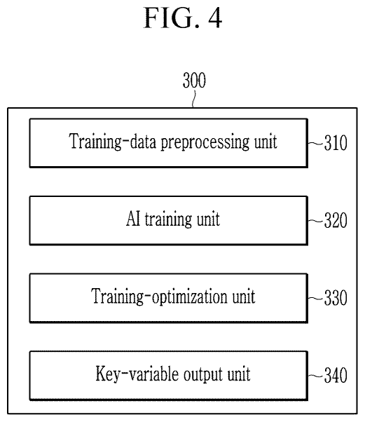

Hereinafter, with reference to FIGS. 4 to 9, the AI module 300 that computes the key variables utilized in valuing the target IP will be described in detail.

As shown in FIG. 4, the AI module 300 may include a training-data preprocessing unit 310, an AI training unit 320, a training-optimization unit 330, and a key-variable output unit 340.

The training-data preprocessing unit 310 may perform preprocessing on the training data received from the training-data generation unit 240.

Specifically, the training-data preprocessing unit 310 may perform duplicate-row handling, outlier handling, and normalization for deterministic AI models, and may perform duplicate-row handling and outlier handling for generative AI models.

The AI training unit 320 may include two or more AI models and may perform training of the AI models using the training dataset.

Specifically, the AI training unit 320 may include one or more of deterministic AI models and generative AI models, and, using the training dataset, may train the AI models to estimate prediction variables for calculating the key variables.

For example, as a deterministic AI model, the AI training unit 320 may use AutoML (Automated Machine Learning) and may be configured as a stacking ensemble model.

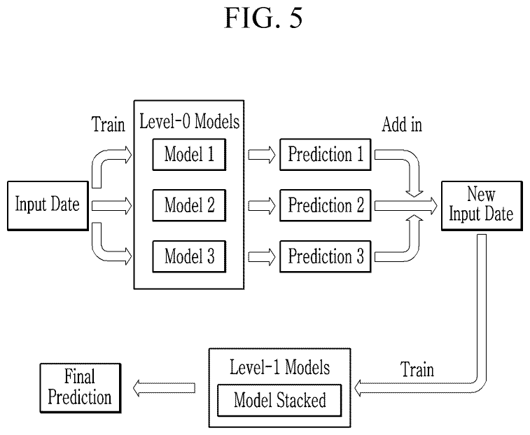

As shown in FIG. 5, the stacking ensemble model includes base models (level-0 models) and a meta-model (level-1 model, final model), and can perform prediction by using the prediction values of a plurality of base models as training data for the final model.

According to the present disclosure, for example, the base models may include a statistics-based model (model1), a tree-based model (model2), and a neural-network model (model3).

In this case, the statistics-based model may include a K-nearest neighbors (KNN) model. Additionally, the tree-based models may include a decision tree model (Decision Tree), a random forest model (Random Forest), an Extra Tree model (Extra Tree), XGBoost, LightGBM, and a CatBoost model. Further, the neural-network model may include a multilayer perceptron model.

In this case, the AI training unit 320 may perform training and prediction for all of the models.

The AI training unit 320 may train the base models using an input dataset, generate prediction values through the trained base models and use the generated prediction values again as input data to the meta model to produce a final prediction value, and may execute model training.

Specifically, the AI training unit 320 may train the respective base models using default hyperparameters and evaluate training performance for multiple combinations of hyperparameters by randomly sampling from a predefined set of hyperparameters.

The AI training unit 320 may generate a weighted average of the prediction values of the respective trained base models, and may use the weighted-average prediction value as new input data to the meta model to generate a final prediction value.

In this case, the AI training unit 320 may generate a plurality of prediction values by varying the features of the training data, the training evaluation metrics, and the initial setting value (seed), and may select the median thereof as the final prediction value.

For example, the AI training unit 320 may generate 27 prediction values by varying three training datasets, three training evaluation metrics, and three initial setting values (seeds), and may select the median thereof as the final prediction value.

In this case, for example, the three initial values may be set to arbitrary random-number seeds of 1, 2, and 3, and the three evaluation metrics may include RMSE (Root Mean Square Error), MAPE (Mean Absolute Percentage Error), and R² (R-squared).

Alternatively, the AI training unit 320 may employ generative models, including a Bayesian neural network (BNN) model, a sparse Gaussian process (Sparse GP) model, and a variational-inference-based sparse Gaussian process (Variational Sparse GP) model.

Specifically, in the case of a BNN, the weights of the hidden layers are defined as latent variables, which are random variables having arbitrary distributions. Further, the dataset used for training is also a random variable having an arbitrary distribution, and the arbitrary distribution of the explanatory-variable set, described in detail below, can be represented as a joint distribution combined with the latent variables.

According to one aspect of the present disclosure, the joint distribution to be estimated is defined as a distribution combining the explanatory variables and the latent variables, and training may be performed so as to minimize a difference between the joint distribution and an arbitrary candidate distribution convenient for estimating the joint distribution; for example, the training may be performed to maximize an evidence lower bound (ELBO) and minimize a Kullback-Leibler (KL) divergence. In this case, the ELBO denotes the expected value of the difference between the joint distribution to be estimated and the candidate distribution. Further, the KL divergence denotes the difference between the conditional distribution for the latent variables with the candidate distribution and the explanatory variables held fixed—that is, between the corresponding joint distributions—and may be understood as the discrepancy between the latent-variable distribution generated on the basis of the given training data and the distribution generated by the candidate distribution.

For the training, a Monte Carlo method may be used, in which distribution values are generated from each of the candidate distribution and the joint distribution, the expected value is defined as the sum of the distribution values, and, with the parameters of the joint distribution fixed, parameters of the candidate distribution are determined so as to maximize the expected value. Subsequently, with the parameters of the candidate distribution held fixed, parameters of the joint distribution that minimize the KL divergence may be determined. Thereafter, by again fixing the parameters of the joint distribution and iteratively finding the parameters of the candidate distribution that maximize the ELBO, the joint distribution may be learned.

Through the foregoing processes, when the respective parameters no longer change or a predetermined number of training iterations is reached, training may be terminated, and a predetermined number of prediction values may be generated from the joint distribution constituted by the learned parameters.

Next, in the case of a sparse Gaussian process (Sparse GP) model, a GP is a distribution over functions and may be understood as a distribution composed of arbitrary functions with respect to given explanatory variables. The distribution takes the form of a multivariate normal distribution having a mean function and a covariance function; since the GP is used as a prior distribution for inference of the prediction variable, the mean function may be set to zero, and the covariance function may be assumed to be an arbitrary function defined over the explanatory variables. In this case, the covariance function may be assumed to be a radial basis function (RBF) kernel. The radial basis function kernel is a function that represents relationships among data and may be composed of parameters that characterize the given data.

In this case, given the explanatory variables, each prediction variable is represented as a distribution generated by the predefined GP, i.e., a combination of the GP over the explanatory variables and a random error term. Accordingly, in the GP as well, parameters of the random error and of the kernel function that maximize the likelihood of the predictive distribution must be estimated. A value obtained by adding random noise—assumed to follow a normal distribution—to the GP over the given explanatory variables may be generated via a Monte Carlo method, and the parameters may be estimated for the generated values using numerical analysis techniques. In this case, when the data size becomes enormous and a large amount of computation is required, points at which the data are examined may be designated within the data space to reduce the computational load and enable rapid training.

Further, the variational-inference-based sparse Gaussian process (Variational Sparse GP) model is a GP that, unlike the foregoing GP assumption, does not assume a normal distribution for the random error but instead assumes an arbitrary distribution. That is, it is a model that assumes that the random error of the prediction variable follows an arbitrary distribution.

Accordingly, to assume an arbitrary distribution, an arbitrary distribution may be estimated by using a Monte Carlo method—of the type employed in BNN training—that maximizes the ELBO and minimizes the KL divergence; and, for inference with massive data volumes, as described above for the Sparse GP, the computational load may be reduced and rapid training enabled by reducing the number of evaluation points.

According to one aspect of the present disclosure, as generative AI models, the AI training unit 320 may include all of the foregoing Bayesian neural network (BNN) model, sparse Gaussian process (Sparse GP) model, and variational-inference-based sparse Gaussian process (Variational Sparse GP) model, and may generate ten prediction values for each model, for a total of thirty prediction values.

In this case, the AI training unit 320 may, for example, include both the above-described stacking ensemble model and the generative AI model, generate 27 prediction values through the stacking ensemble model and 30 prediction values through the generative model, thereby generating a total of 57 prediction values, and may use the median thereof as the final prediction value.

Further, the AI training unit 320 may perform training by conducting training and validation for both the stacking ensemble model and the generative AI model on the entire training dataset, for example at a 9:1 ratio of training to validation.

Meanwhile, the AI training unit 320 may, by varying the input variables to prepare different training datasets, train either the stacking ensemble model as a deterministic model or the generative AI model.

For example, according to one aspect of the present disclosure, the AI model may be trained using: an explanatory-variable set A including variables that are correlated with the prediction variable at a Pearson correlation significance level of less than 0.05; an explanatory-variable set B that additionally includes statistical measures of the variables for which a correlation exists; and an explanatory-variable set C that, by also reflecting variables having no correlation, includes all rating-evaluation factors of the rating evaluation system.

Since incorporating excessive information into model training can increase model complexity and degrade predictive performance, and incorporating insufficient information can likewise degrade performance, the present disclosure takes into account both loss of information and parsimony and may distinguish and compare variable groups accordingly.

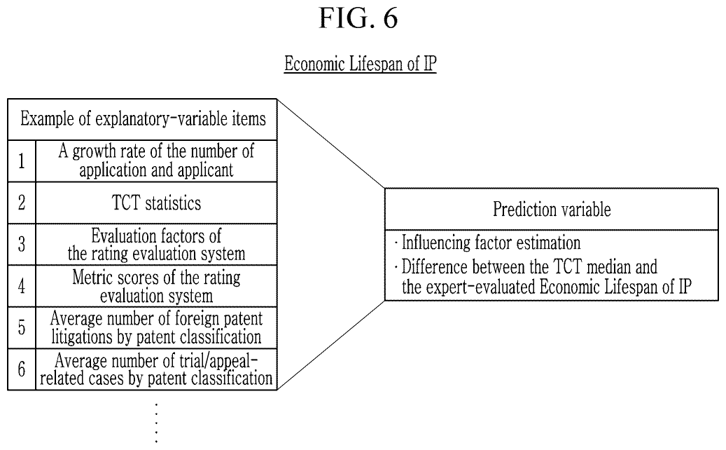

More specifically, in outputting the first key variable, the AI training unit 320 may, for predicting the first prediction variable (i.e., the factor influencing the Economic Lifespan of IP of the target IP), utilize explanatory variables such as those illustrated in FIG. 6 and, may utilize three explanatory-variable sets.

In this case, each explanatory-variable set may commonly include: a growth rate of the number of application and applicant; an industry-specific HHI (Herfindahl-Hirschman Index); metric scores of the rating evaluation system; TCT statistics; and U.S. litigation or trial/appeal statistics by IPC.

Further, the explanatory-variable set A additionally includes, among prior-art references, a paper count, a foreign-patent count, a total forward-citation count, an independent-claim length, and a number of independent claims; and the explanatory-variable set B may further include the paper count among prior art, the foreign-patent count among prior art, the total forward-citation count, the independent-claim length, and the number of independent claims, together with IPC-wise averages thereof—namely, an IPC-wise average paper count among prior art, an IPC-wise average foreign-patent count among prior art, an IPC-wise average total forward-citation count, an IPC-wise average independent-claim length, and an IPC-wise average number of independent claims. Further, the explanatory-variable set C may additionally include all evaluation factors of the rating evaluation system.

In this case, the rating evaluation system (e.g., SMART5) is a rating evaluation system based on: specification information (number of independent claims, independent-claim length, average depth of dependent claims, length of the description of the invention, number of dependent claims, number of claim chains); bibliographic information (number of IPCs, number of drawings, number of continuing applications/priority claims, number of inventors); examination information (whether early publication was made, whether accelerated examination was requested, number of information submissions, number of Office Action responses); post-registration administrative information (number of annuity registrations, number of changes in right holder, number of foreign family countries, number of licensees, number of pledges established by financial institutions, whether an extension of term has been registered); litigation/trial/appeal information (e.g., number of dismissals in invalidation trials, numbers of upheld/withdrawn/rejected invalidation trials, number of dismissals in negative scope-confirmation trials, numbers of upheld/withdrawn/rejected negative scope-confirmation trials, numbers of dismissed/withdrawn/rejected positive scope-confirmation trials, number of upheld positive scope-confirmation trials, number of appeals from final rejections, number of correction trials); and citation information (total forward-citation count, counts of non-patent literature/foreign patents among references cited by forward-citing patents, difference between filing date and forward-citation date, and counts of papers/foreign patents among prior-art references).

The rating evaluation system assigns, for the target IP, a score based on the value of each of the above-described thirty-two evaluation factors and assigns a grade according to score ranges.

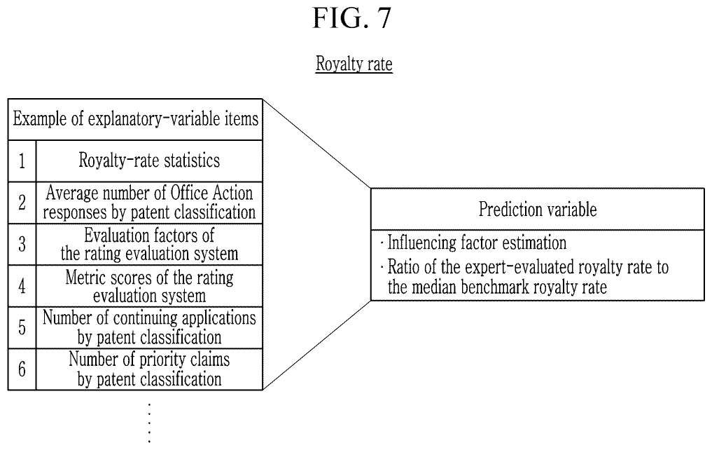

Further, in outputting the second key variable, the AI training unit 320 may, for predicting the second prediction variable (a factor influencing the benchmark royalty rate), utilize explanatory variables such as those illustrated in FIG. 7 and, may utilize three explanatory-variable sets.

In this case, each explanatory-variable set may commonly include: counts of continuing applications and priority claims; the number of Office Action responses; industry sales-growth rates; royalty-rate statistics; trial/appeal statistics by IPC; and metric scores of the rating evaluation system.

Further, the explanatory-variable set A may additionally include a difference between the filing date and the forward-citation date, an average depth of dependent claims, a number of independent claims, an independent-claim length, and TCT statistical values; and the explanatory-variable set B may additionally include the difference between the filing date and the forward-citation date, the average depth of dependent claims, the number of independent claims, the independent-claim length, TCT statistical values, together with IPC-wise averages thereof-namely, an IPC-wise average count of continuing applications and priority claims, an IPC-wise average number of Office Action responses, an IPC-wise average difference between filing date and forward-citation date, an IPC-wise average of the average depth of dependent claims, an IPC-wise average number of independent claims, and an IPC-wise average independent-claim length. Further, the explanatory-variable set C may additionally include all evaluation factors of the rating evaluation system.

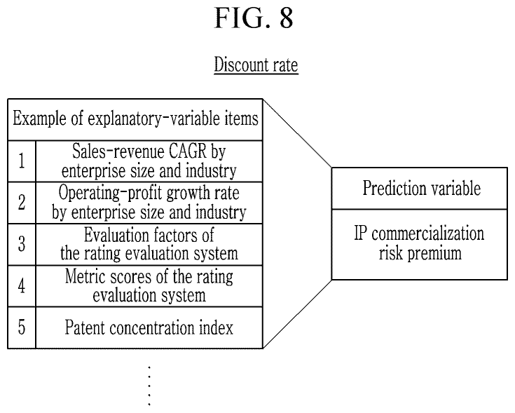

Further, in outputting the third key variable, the AI training unit 320 may, for predicting the third prediction variable—an IP commercialization risk premium—utilize explanatory variables such as those illustrated in FIG. 8 and, may utilize three explanatory-variable sets.

In this case, each explanatory-variable set may commonly include: sales growth rates by enterprise size and industry, operating-profit growth rates by enterprise size and industry, patent concentration index, and metric scores of the rating evaluation system.

Further, the explanatory-variable set A may additionally include an independent-claim length, a count of foreign-patent citations among references cited by forward-citing patents, an industry-specific business-cycle index, and trial/appeal statistics by IPC; and the explanatory-variable set B may additionally include an independent-claim length, a count of foreign-patent citations among references cited by forward-citing patents, an industry-specific business-cycle index, an IPC-wise average independent-claim length, an IPC-wise average count of foreign-patent citations among references cited by forward-citing patents, and trial/appeal statistics by IPC. Further, the explanatory-variable set C may additionally include all evaluation factors of the rating evaluation system.

Meanwhile, in outputting the fourth key variable, the AI training unit 320 may perform training for estimating the fourth prediction variable—a sales growth rate—by including an ARIMA (Autoregressive Integrated Moving Average) model or an ETS (Exponential Smoothing) model.

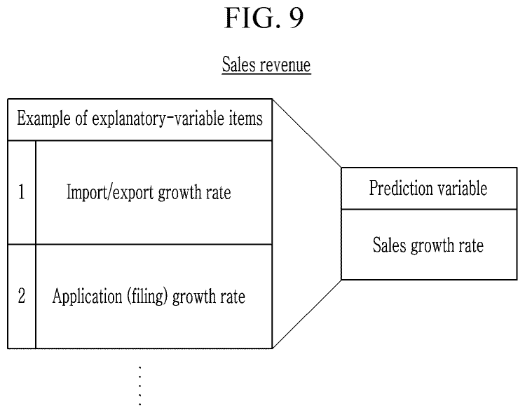

In outputting the fourth key variable, the AI training unit 320 may utilize explanatory variables such as those illustrated in FIG. 9 and, may train a model for estimating the sales growth rate by incorporating, as training data, IPC-wise growth rates of the number of applicants and the number of applications, IPC-wise sales-revenue growth rates, and import/export growth rates, and may perform training by splitting the dataset into training and validation sets at an 8:2 ratio.

In this case, the ARIMA model may include ARIMA, SARIMA (Seasonal ARIMA), ARIMAX (Autoregressive Integrated Moving Average Exogenous), and SARIMAX (Seasonal Autoregressive Integrated Moving Average Exogenous).

Further, the ETS model may include Holt-Winter's seasonal, Holt-Winters damped, damped trend, and SES (Simple Exponential Smoothing).

The AI training unit 320 may perform model performance evaluation using a validation set by computing an absolute difference in CAGR between predicted and actual values, a mean absolute error (MAE), and a mean squared error (MSE).

The training-optimization unit 330 may, based on the training of the AI models by the AI training unit 320 and the validation results for the model prediction values, set an optimal combination of parameters for each AI model for calculating the key variables.

The training-optimization unit 330 may, in the stacking ensemble model, remove training-data features having low importance according to performance evaluation results of the respective base models and may perform additional hyperparameter tuning for models exhibiting good performance.

Further, in the ARIMA model, the training-optimization unit 330 may treat as model parameters an AR order p, an MA order q, a differencing order d, a seasonal AR order P, a seasonal MA order Q, and a seasonal differencing order D, and, among possible parameter combinations, may select an optimal combination by deriving the combination that minimizes the corrected Akaike information criterion (AICc).

Further, in the ETS model, the training-optimization unit 330 may treat as model parameters alpha (smoothing_level), beta (smoothing_trend), initial_level l₀, initial_trend b₀, gamma (seasonality), phi (damping_trend), and s₀, s₁, s₂, s₃ (initial_seasons), and may fit these parameters to the training dataset using the L-BFGS-B method (a quasi-Newton method).

Specifically, for outputting the first key variable—the Economic Lifespan of IP of the target IP—the training-optimization unit 330 may set, as an optimized set of explanatory variables for predicting the factor influencing the Economic Lifespan of IP, a growth rate of the number of applications and applicants (application-growth rate/applicant-growth rate), TCT statistical values, evaluation factors of a rating evaluation system, metric scores of the rating evaluation system, an average number of U.S. patent litigations by IPC, and an average number of trial/appeal-related cases by IPC as a first explanatory-variable set, and may set two or more optimized AI models according to performance-metric results.

Further, for example, to output the second key variable—the royalty rate of the target IP—the training-optimization unit 330 may set, as an optimized set of explanatory variables for predicting a factor influencing the benchmark royalty rate, royalty-rate statistics, an IPC-wise average number of Office Action responses, evaluation factors of a rating evaluation system, metric scores of the rating evaluation system, and counts of continuing applications and priority claims by IPC as a second explanatory-variable set, and may set two or more optimized AI models according to performance-metric results.

Further, to output the third key variable—the discount rate—the training-optimization unit 330 may set, as an optimized set of explanatory variables for predicting the IP commercialization risk premium, sales growth rates by enterprise size and industry, operating-profit growth rates by enterprise size and industry, evaluation factors of the rating evaluation system, metric scores of the rating evaluation system, and patent concentration index as a third explanatory-variable set, and may set two or more optimized AI models according to performance-metric results.

Further, to output the fourth key variable—sales revenue—the training-optimization unit 330 may set, as an optimized set of explanatory variables for estimating the sales growth rate, growth rates of the number of applicants and of the number of applications and import/export growth rates as a fourth explanatory-variable set, and may set two or more optimized AI models according to performance-metric results.

The key-variable output unit 340 may output the respective key variables for valuing the target IP.

The key-variable output unit 340 may generate prediction variables through two or more AI models optimized for the respective key variables and may compute the respective key variables based on the prediction variables.

Specifically, the key-variable output unit 340 may output the first through fourth key-variable values and, to compute the respective key variables, may first compute the first through fourth prediction-variable values.

That is, the key-variable output unit 340 may identify the first explanatory-variable set to compute a first prediction-variable value and, based on the first prediction-variable value, compute a first key-variable value.

Similarly, the key-variable output unit 340 may sequentially compute the second prediction variable and the second key-variable value through the second explanatory-variable set, and compute the third prediction variable and the third key-variable value through the third explanatory-variable set. Further, the key-variable output unit 340 may identify the fourth explanatory-variable set to compute a fourth prediction-variable value and a fourth key-variable value.

Meanwhile, when, for each of the first through fourth key variables, the key-variable output unit 340 has obtained two or more first through fourth prediction-variable values via two or more AI models, it may, according to respective first through fourth criteria, either select a particular value or obtain a statistically processed value for the respective results.

According to one aspect of the present disclosure, the first key variable is the Economic Lifespan of IP of the target IP.

The key-variable output unit 340 may, through the first explanatory-variable set and the AI model set by the training-optimization unit 330, compute, as the first prediction variable, a factor influencing the Economic Lifespan of IP.

The key-variable output unit 340 may ascertain the TCT (Technology Cycle Time) median for the IPC to which the target IP belongs and, by reflecting the first prediction-variable value in the TCT median, compute the first key variable—that is, the Economic Lifespan of IP of the target IP.

Further, according to one aspect of the present disclosure, the second key variable is the royalty rate.

The key-variable output unit 340 may, through the second explanatory-variable set and the AI model set by the training-optimization unit 330, compute, as the second prediction variable, a factor influencing the royalty rate.

The key-variable output unit 340 may set an industry through industry classification information matched to the IP classification information of the target IP, ascertain a benchmark royalty rate value for the industry, and, by reflecting the second prediction-variable value in the benchmark royalty rate value, compute the second key variable—that is, a final royalty rate for the target IP.

Further, according to one aspect of the present disclosure, the third key variable is the discount rate.

The key-variable output unit 340 may, through the third explanatory-variable set and the AI model set by the training-optimization unit 330, compute, as the third prediction variable, an IP commercialization risk premium.

The key-variable output unit 340 may compute a weighted-average cost of capital (WACC) by reflecting, in the cost of equity, the third prediction-variable value—an IP commercialization risk premium—and may output the weighted-average cost of capital as the third key variable, i.e., the discount rate; specific equations are as follows.

$$WACC = [ {K}_{d} \times ( 1 - T ) \times ( \frac{D}{E + D} ) + {K}_{e} \times ( \frac{E}{E + D} ) ] \qquad ( Equation 2 )$$

In this case, K_{d} denotes the cost of debt, Kₑ denotes the cost of equity, T denotes the corporate tax rate, E denotes equity, D denotes debt,

$$\frac{D}{E + D}$$

denotes the debt ratio, and

$$\frac{E}{E + D}$$

denotes the equity ratio.

Meanwhile, the cost of equity may be calculated using the CAPM (Capital Asset Pricing Model) for listed companies, and, in the case of unlisted companies, a size risk premium may be added. The key-variable output unit 340 may further add the computed IP commercialization risk premium to derive the cost of equity (Kₑ) as set forth below, and may then compute the final discount rate according to Equation (2).

$$( Equation 3 )$$

$${K}_{e} = the cost of equity for listed companies + \text{} the size risk premium + The IP commercialization risk premium$$

In this case, for calculating the cost of equity for listed companies, the CAPM is as follows.

$$the CAPM ( Capital Asset Pricing Model ) for listed companies = {R}_{f} + β \times [ E ( {R}_{m} - {R}_{f} ) ] \qquad ( Equation 4 )$$

E(Rₘ): Expected return on the market portfolio.
R_{f}: Risk-free interest rate.
[E(Rₘ−R_{f})]: Market risk premium.
β: Systematic risk sensitivity of the individual asset (company).

The statistical-data generation unit 250 may compute, based on financial information such as stock-price data, bond-yield data, and corporate financial-sheet data, metrics including a market risk premium; for example, it may calculate an expected market return E(Rₘ)) by taking the arithmetic mean of stock index returns over the most recent one-year period, and may calculate a risk-free interest rate (R_{f}) as the average yield on five-year government bonds.

The statistical-data generation unit 250 may compute the market risk premium by subtracting the risk-free interest rate (R_{f}) from the expected market return (E(Rₘ)).

Further, the statistical-data generation unit 250 may compute beta, by industry, by calculating correlation coefficients between stock index returns and individual stock returns.

Meanwhile, the statistical-data generation unit 250 may compute the cost of debt by adding an additional risk spread to the cost of debt of listed companies in the relevant industry.

Specifically, the statistical-data generation unit 250 may, based on financial information such as stock-price data, bond-yield data, and corporate financial-sheet data, compute financing costs for listed companies and, using average spreads by credit rating for unsecured corporate bonds, derive an additional risk spread for unlisted companies relative to the average credit rating of listed companies, thereby computing the cost of debt.

According to one aspect of the present disclosure, the fourth key variable is sales revenue.

The key-variable output unit 340 may, through the fourth explanatory-variable set and the AI model set by the training-optimization unit 330, compute, as the fourth prediction variable, a sales growth rate.

The key-variable output unit 340 may set an initial sales revenue according to the industry and, by reflecting the fourth prediction-variable value in the initial sales revenue, may compute the sales revenue over the economic-life period.

Specifically, when the business entity is identified, the key-variable output unit 340 may set the initial sales revenue based on an average of the business entity's past sales. Further, when the business entity is not identified, the key-variable output unit 340 may set the initial sales revenue using sales statistics by industry, enterprise size, or item.

The key-variable output unit 340 may compute the sales-revenue stream for the period by applying the computed sales growth rate to the initial sales revenue.

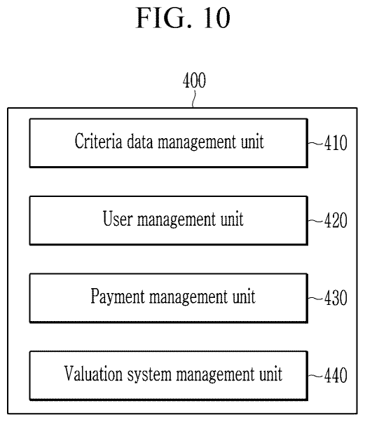

Meanwhile, as shown in FIG. 10, the valuation management module 400 may include a criteria data management unit 410, a user management unit 420, a payment management unit 430, and a valuation system management unit 440.

The criteria data management unit 410 may manage evaluation-criteria information required for executing IP valuation, for example, relevant laws or rules such as tax rates.

The user management unit 420 may manage basic information and history information for users of the system according to the present disclosure, and the payment management unit 430 may perform fee-payment management for use of the system according to the present disclosure. Further, the valuation system management unit 440 may perform resource management for the system according to the present disclosure.

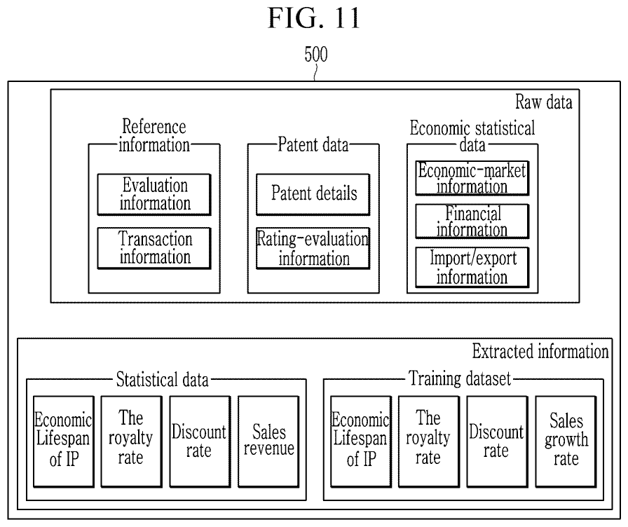

FIG. 11 is a detailed configuration diagram of the valuation database 500 according to one aspect of the present disclosure. As illustrated, the valuation database 500 may include raw data and extracted information that the collection/refinement module 200 has collected and processed.

First, the raw data may include reference information, patent data, and economic statistical information.

The reference information may be information used as a basis in the valuation process of the IP valuation system or serving as validation criteria for system evaluation results using AI models, and may include IP evaluation information and transaction information that have already been completed.

In this case, the IP evaluation information may be IP valuation data completed by experts and may include, for example, an expert-evaluated Economic Lifespan of IP, an expert-evaluated royalty rate, and an expert-evaluated IP commercialization risk premium. Further, the transaction information, as actual IP transaction information, may include university technology transfer data, public research institute technology transfer data, and IP exchange transaction data.

Meanwhile, the patent data may include, as objective patent-related data, patent details and rating-evaluation information.

The patent details may include per-patent forward/backward citation data, application data, trial/appeal data, litigation data, registration data, and family data. Further, the rating-evaluation information, as rating evaluation data performed for each patent, may include the above-described rating-evaluation factor data and, according to the evaluation results for the respective factors, score data for the metrics represented by the respective evaluation factors.

The economic statistical information may include, among public data that are created or acquired and managed by public institutions, economic-market information, financial information, and import/export information required for IP valuation.

In this case, the economic-market information may include industry-specific sales-growth-rate data, sales statistical data, and macro-economic data. The financial information may include stock-price data, bond-yield data, and corporate financial-sheet data. Further, the import/export information may include import/export data.

Next, the extracted information is information processed from the raw data and may include statistical data that are derived in the IP valuation process and provided together with the final valuation result for the target IP, and AI training dataset used for training the AI models.

In this case, the statistical data may include information related to the Economic Lifespan of IP, information related to the royalty rate, information related to the discount rate, and statistical information related to sales revenue.

Specifically, as statistical information utilized or extracted in the course of calculating the Economic Lifespan of IP, it may include, for example, TCT (Technology Cycle Time) data by IPC, trial/appeal-related statistical data, U.S. litigation data, and market-concentration index data for the relevant industrial sector (industry).

Further, as statistical information utilized or extracted in the course of calculating the royalty rate, it may include industry-specific benchmark royalty-rate data and statistical data on the number of Office Action responses, the number of continuing applications, and the number of priority claims by IPC.

Further, as statistical information utilized or extracted in the course of calculating the discount rate, it may include cost-of-equity and cost-of-debt data by industry, equity/debt-ratio data by industry, patent concentration index by the target IPC, and five-year CAGR data (sales revenue and operating profit) by industry and enterprise size for the business sector of the target IP.

Further, as statistical information utilized or extracted in the course of calculating sales revenue, it may include initial sales-revenue statistical data according to the industry and enterprise-size class to which the business entity's target IP belongs, IPC-wise statistics on growth rates of the number of applicants and of the number of applications, and statistics on import/export growth rates for the relevant industry and item.

Meanwhile, the AI training dataset used for training the AI models may include: training dataset input to the AI models for calculating the first key variable—Economic Lifespan of IP; training dataset input to the AI models for calculating the second key variable—royalty rate; training dataset input to the AI models for calculating the third key variable—discount rate; and training dataset input to the AI models for calculating the fourth key variable—sales revenue.

Specific examples of the training dataset respectively utilized for calculating the first through fourth key variables are as described above; therefore, a detailed description thereof will be omitted.

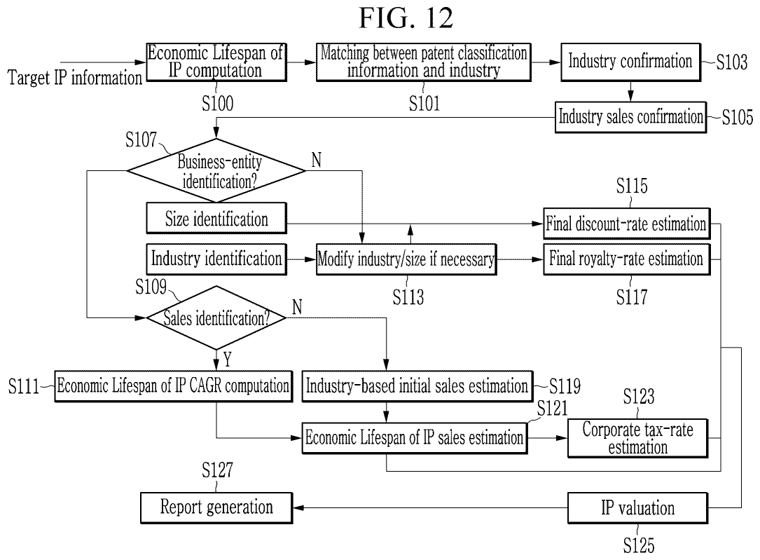

Hereinafter, with reference to FIG. 12, the overall flow of the process executed by the IP valuation system according to one aspect of the present disclosure will be summarized and described.

First, a user may input information on the target IP through the valuation service module 100. For example, the user may input a registration number of a patent to be evaluated.

The AI module 300 may compute the first through fourth key variables for valuing the target IP. First, based on the input registration number, it may ascertain, from the patent data of the valuation database 500, patent classification information for the relevant patent, and may ascertain, from the statistical information of the valuation database 500, TCT statistics for the patent classification information.

The AI module 300 may identify values of the first explanatory-variable set for the target IP from the valuation database 500 and, through the first explanatory-variable set and AI model, compute, as the first prediction variable, a factor influencing the Economic Lifespan of IP.

The AI module 300 may ascertain a TCT (Technology Cycle Time) median for the relevant patent classification information and, by reflecting the first prediction-variable value in the TCT median, compute the first key variable—Economic Lifespan of IP. In this case, the collection/refinement module 200 may ultimately compare the result with the remaining legal life of the target IP and output the shorter as the final Economic Lifespan of IP (S100).

The AI module 300 may identify the corresponding industry by checking industry classification information matched to the patent classification information. Further, the AI module 300 may ascertain sales statistics for the relevant industry from the economic statistical information of the valuation database 500 (S101, S103, and S105).

The AI module 300 may, when the enterprise size or industry is identified from user input information and the economic statistical information of the valuation database 500, proceed to compute the key variables based on the identified size or industry (S107 and S113).

The AI module 300 may identify values of the second explanatory-variable set for the target IP from the valuation database 500 and, using the second explanatory-variable set and the AI model, compute, as the second prediction variable, a factor influencing the royalty rate.

The AI module 300 may ascertain a benchmark royalty rate for the relevant industry from the valuation database 500 and, by reflecting the second prediction-variable value in the benchmark royalty rate, compute the second key variable-a final royalty rate (S117).

The AI module 300 may identify, from the valuation database 500, values of the third explanatory-variable set for the target IP and, using the third explanatory-variable set and the AI model, compute, as the third prediction variable, an IP commercialization risk premium.

The AI module 300 may compute a weighted-average cost of capital (WACC) as a final discount rate by reflecting the third prediction-variable value in the cost of equity for the industry or enterprise-size class to which the target IP belongs, as calculated from the economic statistical information of the valuation database 500 (S115).

Further, the AI module 300 may, based on mapping between the IP classification information and import/export item classification information, identify from the valuation database 500 values of the fourth explanatory-variable set for the target IP and, using the fourth explanatory-variable set and the AI model, compute, as the fourth prediction variable, a sales growth rate.

Further, when the business entity is identified and past sales are confirmed, the AI module 300 may set an initial sales revenue based on an average of the business entity's past sales and, by reflecting the fourth prediction-variable value in the initial sales revenue, compute the sales revenue over the period (S109, S111, and S121).

Meanwhile, when sales are not identified, the AI module 300 may set an initial sales revenue using sales statistics for an enterprise of a predetermined size (e.g., a small enterprise) in the relevant industry and, by reflecting the fourth prediction-variable value, compute the sales revenue (S109, S119, and S121).

Further, the collection/refinement module 200 may compute a final corporate tax expense based on the estimated sales revenue over the economic-life period of the target IP and the final royalty rate, in accordance with a corporate tax rate determined from the sales revenue (S123).

As described above, the valuation service module 100 may, based on the final Economic Lifespan of IP, the final royalty rate, the final discount rate, the estimated sales revenue, and the final corporate tax value, perform valuation of the target IP according to Equation (1) (S125).

Further, the valuation service module 100 may generate a report including the valuation results and the reference information extracted or utilized in the valuation process, together with statistical information on the key variables or various explanatory variables used for estimating the key variables (S127).

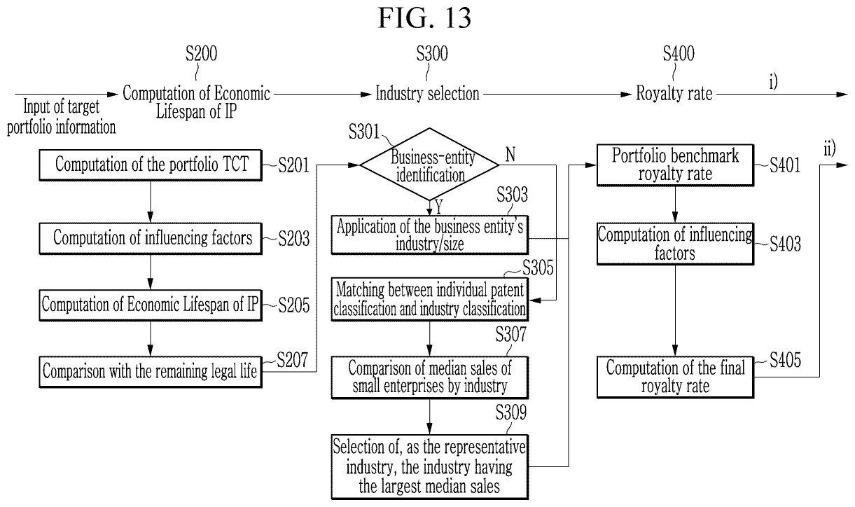

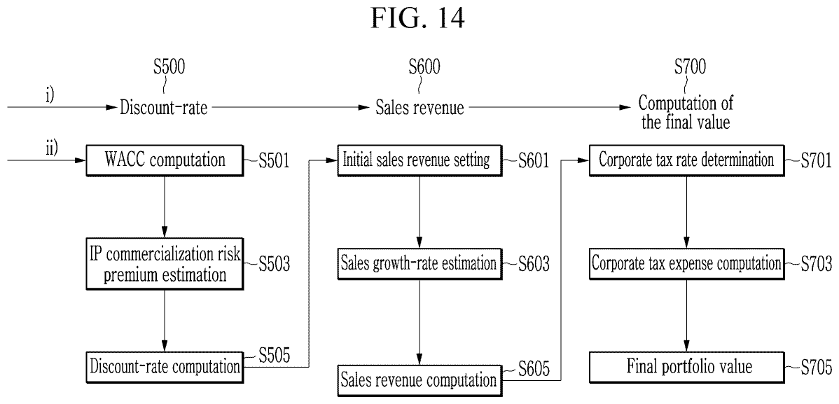

Meanwhile, with reference to FIGS. 13 and 14, the portfolio valuation process of the IP valuation system according to one aspect of the present disclosure will be summarized and described.

First, a user may input target IP portfolio information through the valuation service module 100. For example, the user may input registration numbers of the patents to be evaluated.

The AI module 300 may compute, for the target IP portfolio, the first through fourth key variables and, first, based on the input registration numbers, may ascertain, from the patent data of the valuation database 500, the patent classification information for each individual patent and, from the statistical information of the valuation database 500, TCT (Technology Cycle Time) statistics for the respective patent classification information of the individual patents.

The AI module 300 may set, as a baseline TCT value for the portfolio, the average of the TCT medians for the respective individual patents (S201).

In this case, for each individual patent constituting the portfolio, the AI module 300 may compute, in the same manner as described above, a factor influencing the Economic Lifespan of IP. Further, among the computed values, the AI module 300 may estimate, as the first prediction variable for the target portfolio—that is, as the factor influencing the Economic Lifespan of IP of the target portfolio—the factor having the largest value (S203).

The AI module 300 may, by reflecting the first prediction-variable value for the portfolio in the baseline TCT value for the portfolio, compute the first key variable for the portfolio—that is, the Economic Lifespan of IP for the portfolio (S205).

Further, the collection/refinement module 300 may ultimately compare the result with the remaining legal life of each individual patent and output the shortest as the final Economic Lifespan of IP of the target portfolio (S207).

That is, if the Economic Lifespan of IP computed in S205 is shorter than the shortest remaining legal life, the computed Economic Lifespan of IP is adopted as is; if the Economic Lifespan of IP is longer than the shortest remaining legal life, the shortest remaining legal life replaces the Economic Lifespan of IP computed in S205.

Meanwhile, when the enterprise size or industry is identified from user input information or from the economic statistical information of the valuation database 500, the AI module 300 may proceed to compute the key variables for the portfolio based on the identified size or industry (S301 and S303).

Further, when the business entity is not identified, the AI module 300 may, for each individual IP, identify the respective industry through industry classification information matched to the IP classification information, assume the enterprise size to be a small enterprise, and ascertain from the valuation database 500 the median sales of small enterprises for the respective industries and compare them (S301, S305, and S307). Further, the AI module 300 may set, as the representative industry of the IP portfolio, the industry having the largest median sales (S309).

Further, the AI module 300 may ascertain, from the valuation database 500, a benchmark royalty rate for the representative industry of the IP portfolio and set it as the benchmark royalty rate for the IP portfolio (S401).

Further, for each individual patent constituting the portfolio, the AI module 300 may compute, in the same manner as described above, a factor influencing the royalty rate. Further, the AI module 300 may estimate, as the second prediction variable for the target portfolio—that is, as the factor influencing the royalty rate of the target portfolio—the factor having the largest value among the computed values (S403).

The AI module 300 may, by reflecting the portfolio's royalty-rate influencing-factor value in the portfolio's benchmark royalty rate, compute a final royalty rate for the portfolio (S405).

Meanwhile, the AI module 300 may compute a weighted-average cost of capital (WACC) for the portfolio by using a cost of equity and its weight and a cost of debt and its weight, as derived from the economic statistical information of the valuation database 500 for the portfolio's representative industry (S501).

In this case, the AI module 300 may, in the same manner as described above, compute an IP commercialization risk premium for each individual IP and may estimate, as the third prediction variable for the target portfolio—that is, as the IP commercialization risk premium of the target portfolio—the IP commercialization risk premium having the smallest value among these (S503).

The AI module 300 may, by reflecting the estimated IP commercialization risk premium of the portfolio in the cost of equity within the weighted-average cost of capital (WACC) for the portfolio's industry, compute a final discount rate for the portfolio (S505).

Further, the AI module 300 may set an initial sales revenue; when the business entity is identified and the business entity's past sales are confirmed from the economic statistical information of the valuation database 500, it may assume, as the initial sales revenue at the end of the year immediately preceding the valuation time, an average of the past sales (e.g., an average of past three to five years of sales) (S601).

Further, based on mapping between the import/export item classification information and the IP classification information derived from the representative industry of the portfolio, the AI module 300 may, in the same manner as described above, estimate, as the fourth prediction variable for the target portfolio, a sales growth rate for the target portfolio (S603).

Meanwhile, when the business entity or sales information is unavailable, the AI module 300 may set the initial sales revenue using sales statistics for an enterprise of a predetermined size (e.g., a small enterprise) in the representative industry of the portfolio.

The AI module 300 may compute the sales revenue for a set period by applying the portfolio's sales growth rate to the initial sales revenue (S605).

Meanwhile, when the sales growth rate is estimated on a quarterly basis, the AI module 300 may convert the quarterly sales growth rate into an annual growth rate using a geometric mean, and, similarly, the total period is limited to the IP economic-life period.

Further, the collection/refinement module 200 may determine a corporate tax rate based on the sales revenue over the economic-life period of the IP portfolio; for example, the corporate tax rate may be determined based on an average of the sales revenue over the entire period (S701).

The collection/refinement module 200 may compute a corporate tax expense by reflecting the portfolio's estimated sales revenue, final royalty rate, and corporate tax rate (S703).

The valuation service module 100 may, based on the final Economic Lifespan of IP, final royalty rate, final discount rate, estimated sales revenue, and final corporate tax expense for the portfolio, compute a final value of the IP portfolio according to Equation (1) (S705).

Further, the valuation service module 100 may generate a report including not only the valuation results but also the reference information extracted or utilized in the valuation process for the IP portfolio, together with statistical information on the key variables or various explanatory variables used for estimating the key variables.

Accordingly, according to the present disclosure, portfolio-wide valuation can be performed expeditiously, objectively, and efficiently without being affected by the number of individual IPs included in the portfolio.

Further, according to the present disclosure, by integrally utilizing patent data and economic statistical information to perform IP valuation and provide statistical information, the objectivity and reliability of the valuation results can be improved.

Further, according to the present disclosure, by providing to the user not only the direct IP valuation results but also related patent and industry statistical information, great utility can be afforded in the user's understanding of the industry related to the target IP and in the interpretation and utilization of the valuation results.

According to the present disclosure, by providing, in addition to the reference information, statistical information on the key variables that are output and on the various explanatory variables used for estimating the key variables, the reliability and utility of the valuation results can be enhanced.

Further, according to the present disclosure, in calculating the respective key variables for IP valuation, instead of the qualitative evaluation indicators conventionally used in expert evaluations, data-based objective statistical data grounded in patent data and economic statistical information are identified and utilized, thereby improving the objectivity of the valuation results.

Further, according to the present disclosure, by continuously collecting raw data and processing the raw data to generate new statistical data and AI training dataset for outputting the key variables, the timeliness and suitability of the related information utilized in the IP valuation process can be efficiently ensured.

Further, according to the present disclosure, in outputting the key variables, estimation results of two or more AI models optimized for the respective key variables can be utilized, thereby enhancing the objectivity and reliability of the valuation results.

Further, according to the present disclosure, in generating training dataset for training the AI models, valuation data of multiple experts accumulated over a long period and actual transaction data can be reflected, thereby further enhancing the reliability of the valuation results.

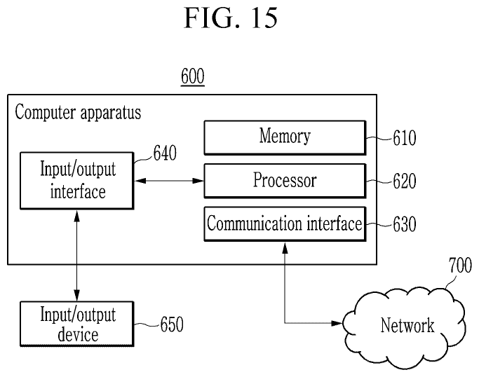

FIG. 15 is a diagram illustrating an example of a computer apparatus according to an embodiment of the present disclosure. The foregoing valuation processes of the IP valuation system according to one aspect of the present disclosure may be implemented by the computer apparatus 600 illustrated in FIG. 15.

Such a computer apparatus 600, as shown in FIG. 15, may include a memory 610, a processor 620, a communication interface 630, and an input/output interface 640. The memory 610, as a computer-readable storage medium, may include RAM (random access memory), ROM (read-only memory), and a nonvolatile mass storage device such as a disk drive. Here, nonvolatile mass storage devices such as ROM and disk drives may be included in the computer apparatus 600 as separate permanent storage devices distinct from the memory 610. Additionally, an operating system and at least one program code may be stored in the memory 610. These software components may be loaded into the memory 610 from a computer-readable storage medium separate from the memory 610. Such a separate computer-readable storage medium may include computer-readable storage media such as a floppy drive, a disk, a tape, a DVD/CD-ROM drive, and a memory card. In another embodiment, the software components may be loaded into the memory 610 via the communication interface 630 rather than from a computer-readable storage medium. For example, the software components may be loaded into the memory 610 of the computer apparatus 600 based on a computer program installed from files received via the network 700.

The processor 620 may be configured to process instructions of a computer program by performing basic arithmetic, logic, and input/output operations. The instructions may be provided to the processor 620 by the memory 610 or by the communication interface 630. For example, the processor 620 may be configured to execute received instructions according to program code stored in a storage device such as the memory 610.

The communication interface 630 may provide functionality for the computer apparatus 600 to communicate with other devices (e.g., the storage devices described above) via the network 700. For example, requests or commands, data, files, and the like generated by the processor 620 in accordance with program code stored in a storage device such as the memory 610 may, under the control of the communication interface 630, be transmitted to other devices via the network 700. Conversely, signals, commands, data, files, and the like from other devices may be received by the computer apparatus 600 via the communication interface 630 through the network 700. Signals, commands, data, and the like received via the communication interface 630 may be delivered to the processor 620 or the memory 610, and files and the like may be stored in a storage medium (the above-described permanent storage device) that the computer apparatus 600 may further include.

The input/output interface 640 may be a means for interfacing with an input/output device 650. For example, the input device may include devices such as a microphone, a keyboard, or a mouse, and the output device may include devices such as a display or a speaker. In another example, the input/output interface 640 may be a means for interfacing with a device in which input and output functions are integrated into one, such as a touchscreen. The input/output device 650 may be configured together with the computer apparatus 600 as a single device.

Additionally, in other embodiments, the computer apparatus 600 may include fewer or more components than those illustrated in FIG. 14. However, it is not necessary to explicitly illustrate most prior-art components. For example, the computer apparatus 600 may be implemented to include at least some of the above-described input/output devices 650 and/or may further include other components such as a transceiver, a database, and the like.

The embodiments described above may be implemented in the form of a computer program executable through various components on a computer, and such a computer program may be recorded on a computer-readable storage medium. In this case, the medium may include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, and flash memory.

Unless the order is expressly specified or a description to the contrary is provided, the steps constituting the method according to embodiments of the present disclosure may be performed in any suitable order. It should be understood that the present disclosure is not limited by the order in which the steps are recited. The use of all examples or exemplary terminology (for example, etc.) in the present disclosure is merely to describe the present disclosure in detail and is not intended to limit the scope of the present disclosure. In addition, those skilled in the art will appreciate that various modifications, combinations, and changes may be made without departing from the scope of the appended claims and their equivalents.

The embodiments of the present disclosure described above are not limited to implementation only through apparatuses and methods, and may also be implemented by a program that realizes functions corresponding to the configurations of the embodiments of the present disclosure or by a recording medium on which such a program is recorded.

While embodiments of the present disclosure have been described in detail above, the scope of the disclosure is not limited thereto, and various modifications and improvements made by those skilled in the art using the basic concept defined in the following claims also fall within the scope of the present disclosure.

1. An AI (Artificial Intelligence)-based IP (Intellectual Property) valuation system, comprising:
a valuation database that includes, as raw data, reference information, patent data, and economic statistical information, and that includes, as extracted information processed from the raw data, statistical data and AI training dataset;
a collection/refinement module that collects and processes the raw data and, in a process of generating the AI training dataset or first through fourth key variables, computes the statistical data required therefor and the AI training dataset, and stores them in the valuation database;
an AI module that, for outputting the first through fourth key variables, trains, using the AI training dataset, two or more AI models for each key variable, identifies, based on input information on a target IP to be evaluated, explanatory variables matched to each key variable, and computes, through the AI models and using respective explanatory-variable values collected or computed by the collection/refinement module, corresponding prediction-variable values to thereby output respective key-variable values, wherein the AI module outputs a first prediction variable and a first key-variable value through a first explanatory-variable set, outputs a second prediction variable and a second key-variable value through a second explanatory-variable set, outputs a third prediction variable and a third key-variable value through a third explanatory-variable set, and outputs a fourth prediction variable and a fourth key-variable value through a fourth explanatory-variable set; and
a valuation service module that, based on the first through fourth key-variable values, computes a value of the target IP via a relief-from-royalty method and generates a valuation report including the IP value and the statistical data;
wherein the AI module identifies, from the input target-IP information, patent classification information to which the target IP belongs and identifies industry classification information matched thereto; ascertains a TCT (Technology Cycle Time) median for the patent classification information and, by reflecting the first prediction-variable value in the TCT median, outputs the first key variable; ascertains, through the industry classification information matched to the patent classification information, a benchmark royalty rate for the relevant industry and, by reflecting the second prediction-variable value in the benchmark royalty rate, outputs the second key variable; ascertains, through the industry classification information matched to the patent classification information, a cost of equity and its weight and a cost of debt and its weight for the relevant industry and, by reflecting the third prediction-variable value in the cost of equity, outputs the third key variable; and, when past sales of a business entity owning the target IP are confirmed, sets an initial sales revenue based on the past sales, and, when past sales are not confirmed, sets the initial sales revenue using sales statistics by preset enterprise sizes in the relevant industry, and, by reflecting the fourth prediction-variable value in the initial sales revenue, outputs the fourth key variable;
wherein the first through fourth key variables are, respectively, an Economic Lifespan of IP, a royalty rate, a discount rate, and a sales revenue; and
wherein the first through fourth prediction variables are, respectively, a factor influencing the Economic Lifespan of IP, a factor influencing the royalty rate, an IP commercialization risk premium, and a sales growth rate which, when training the AI models, are defined as: a difference between an expert evaluation result for Economic Lifespan of IP and a TCT median for the patent classification information to which the target IP belongs; a ratio between an expert-evaluated royalty rate and a benchmark royalty rate for the industry matched—via the industry classification information—to the patent classification information to which the target IP belongs;
an expert-evaluated IP commercialization risk premium; and an industry-specific sales growth rate; and
wherein, when the number of target IPs to be evaluated is two or more and constitutes an IP portfolio, the AI module sets, from TCT statistical values for the respective patent classification information of the individual patents, a baseline TCT value for the target IP portfolio; sets, from factors influencing the Economic Lifespan of IP computed for the respective individual patents, a first prediction variable for the portfolio; and, by reflecting the first prediction-variable value for the portfolio in the baseline TCT for the portfolio, outputs a first key variable for the portfolio; sets, according to user input information, an industry, or—among the industries according to industry classification information matched to the respective patent classification information of the individual patents—sets a representative industry for the target portfolio; sets, as a benchmark royalty rate for the portfolio, a benchmark royalty rate for the representative industry of the target portfolio;
sets, from factors influencing the royalty rate computed for the respective individual patents, a second prediction variable for the target portfolio; and, by reflecting the second prediction-variable value for the portfolio in the portfolio benchmark royalty rate, outputs a second key variable for the portfolio;
sets, from IP commercialization risk premiums computed for the respective individual patents, a third prediction variable for the target portfolio and, by reflecting the third prediction-variable value in the cost of equity within a weighted-average cost of capital for the representative industry of the portfolio, outputs a third key variable for the portfolio; and
derives a sales growth rate from the representative industry of the target portfolio to generate a fourth prediction variable for the target portfolio, sets an initial sales revenue based on past sales information of the business entity or on sales statistics of the representative industry of the target portfolio, and, by reflecting the fourth prediction-variable value in the initial sales revenue, outputs a fourth key variable for the target portfolio.

2. The system of claim 1, wherein the target IP information is the patent registration number of the target IP.

3. The system of claim 2, wherein
the reference information includes expert IP valuation result data and actual IP transaction information data;
the patent data includes, as patent details, per-patent forward/backward citation data, application data, trial/appeal data, litigation data, registration data, and family data, and, as rating-evaluation information, per-patent rating-evaluation factor data and score data for the metrics represented by the respective evaluation factors according to evaluation results for the respective factors; and
the economic statistical information includes, as economic-market information, industry-specific sales-growth-rate data, sales statistical data, and macro-economic data, as financial information, stock-price data, bond-yield data, and corporate financial-sheet data, and, as import/export information, import/export data.

4. The system of claim 2, wherein the collection/refinement module comprises:
a raw-data collection unit configured to collect the raw data;
a preprocessing unit configured to perform preprocessing on the collected raw data;
a base-data generation unit configured to generate base data for computing training data and evaluation-criteria data from the preprocessed data:
a training-data generation unit configured to generate AI-model training dataset for outputting the key variables from the base data;
a statistical-data generation unit configured to generate statistical data for one or more of the explanatory variables, the prediction variables, and the key variables, the statistical data being generated or required in the course of generating the AI training dataset or the key variables; and
an evaluation-criteria-data generation unit configured to compute, based on the first through fourth key-variable values output by the AI module, final evaluation-criteria data and deliver the same to the valuation service module.

5. The system of claim 4, wherein the evaluation-criteria-data generation unit finally computes, as evaluation-criteria data, an Economic Lifespan of IP as the first key-variable value by taking into account at least one of a remaining legal life of the target IP and a commercialization lead time, and computes, based on the computed sales revenue, a corporate tax rate and a corporate tax.

6. The system of claim 4, wherein the statistical data comprise:
(i) as statistical information utilized or extracted in the course of outputting the first key variable, TCT data for the relevant patent classification, trial/appeal-related statistical data, U.S. litigation data, and market-concentration index data for the relevant industrial field;
(ii) as statistical information utilized or extracted in the course of outputting the second key variable, benchmark royalty-rate data for the relevant industry and data on the number of Office Action responses, the number of continuing applications, and the number of priority claims for the relevant patent classification;
(iii) as statistical information utilized or extracted in the course of outputting the third key variable, costs of equity and of debt by industry, equity/debt ratios by industry, patent concentration index for the relevant patent classification, and sales-revenue/operating-profit growth-rate data for the relevant industry; and
(iv) as statistical information utilized or extracted in the course of outputting the fourth key variable, initial sales-revenue statistical data according to the industry and enterprise-size class to which the target IP belongs, statistics on growth rates of the number of applicants and of the number of filings for the relevant patent classification, and import/export growth-rate data for the relevant industry and item.

7. The system of claim 2, wherein the AI module comprises:
a training-data preprocessing unit configured to perform preprocessing on the AI training dataset;
an AI training unit configured to train, using the AI training dataset, one or more AI models for each of the first through fourth key variables;
a training-optimization unit configured to, based on validation results for prediction values of the AI models, set, for each key variable, two or more optimized AI models according to performance-metric results; and
a key-variable output unit configured to compute the key variables using explanatory variables matched to the respective key variables and prediction variables output by the AI models.

8. The system of claim 1, wherein:
the first explanatory-variable set for generating the first prediction variable comprises a growth rate of the number of application and applicant (application-growth rate/applicant-growth rate), TCT statistical values, evaluation factors of a rating evaluation system, metric scores of the rating evaluation system, an average number of U.S. patent litigations by patent classification information, and an average number of trial/appeal-related cases by patent classification information;
the second explanatory-variable set for generating the second prediction variable comprises royalty-rate statistics, an average number of Office Action responses by patent classification, evaluation factors of the rating evaluation system, metric scores of the rating evaluation system, and counts of continuing applications and priority claims by patent classification;
the third explanatory-variable set for generating the third prediction variable comprises, as optimized explanatory variables for predicting an IP commercialization risk premium, sales-growth rates by enterprise size and industry, operating-profit growth rates by enterprise size and industry, evaluation factors of the rating evaluation system, metric scores of the rating evaluation system, and patent concentration index; and
the fourth explanatory-variable set for generating the fourth prediction variable comprises growth rates of the number of applicants and of the number of applications, and import/export growth rates.
